(19) United States
(12) Patent Application Publication
(10) Pub. No.: US 2023/0131796 A1
(43) Pub. Date: Apr. 27, 2023

(54) LIQUID CRYSTAL DISPLAY, AND BACKLIGHT MODULE AND DISPLAYING MODULE THEREOF

(71) Applicant: Wistron Corporation, New Taipei City (TW)

(72) Inventors: CHUNLEI ZHAO, New Taipei City (TW); Yao-Chen Yang, New Taipei City (TW); Chia-Jang Chen, New Taipei City (TW); Chih-Chou Chou, New Taipei City (TW)

(73) Assignee: Wistron Corporation, New Taipei City (TW)

(21) Appl. No.: 17/573,614

(22) Filed: Jan. 11, 2022

(30) Foreign Application Priority Data
Oct. 26, 2021 (CN) 202111249519.X

(51) Int. Cl. F21V 8/00; G02F 1/1333

(52) U.S. Cl. CPC G02B 6/0088; G02F 1/133314

(57) ABSTRACT

A liquid crystal display includes a casing and a displaying module disposed in the casing. The displaying module includes a backlight module and a liquid crystal panel stacked on the backlight module. The backlight module includes a back chassis and a light-guiding plate. The back chassis has a bottom plate portion and a side portion bent from the bottom plate portion and forms an accommodating space therebetween. The back chassis has a constraining portion in the accommodating space. The light-guiding plate is accommodated in the accommodating space. At least a portion of the light-guiding plate is located between the constraining portion and the bottom plate portion.

### BACKGROUND OF THE INVENTION

### 1. Field of the Invention

The present invention relates to a liquid crystal display, and a backlight module and a displaying module thereof.

### 2. Description of the Prior Art

The backlight module of a conventional liquid crystal display usually use a back chassis and a plastic frame engaged to the back chassis to form a fixing frame for accommodating and fixing a light-guiding plate, optical films and other light-guiding elements. The plastic frame usually extends in an L-shaped cross-section and is engaged to a side portion of the back chassis. The vertical portion of the plastic frame and the side portion of the back chassis will be provided with corresponding engaging structures for engaging with each other, such as hooks and grooves. The horizontal portion of the plastic frame can press against and fix the optical films and the light-guiding plate in the vertical direction. In order to make the fixing frame have a certain structural strength, the plastic frame usually has a certain thickness, causing the size of the fixing frame (including length, width, and height) to inevitably include the thickness of the plastic frame, which is not conducive to the reduction of the overall thickness of the liquid crystal display, and is also not conducive to the narrow frame design of the liquid crystal display.

### SUMMARY OF THE INVENTION

An objective of the invention is to provide a backlight module that directly uses a back chassis to accommodate and fix a light-guiding plate without a plastic frame, which is beneficial to reduce the overall size of the backlight module, which is conducive to the reduction of the overall thickness of a liquid crystal display using this backlight module and is also conducive to the narrow frame design of the liquid crystal display.

A backlight module according to the invention is used in a display and includes a back chassis and a light-guiding plate. The back chassis has a bottom plate portion and a side portion bent from the bottom plate portion. The back chassis forms an accommodating space between the bottom plate portion and the side portion. The back chassis has a constraining portion located in the accommodating space. The light-guiding plate is accommodated in the accommodating space. At least a portion of the light-guiding plate is located between the constraining portion and the bottom plate portion. Thereby, the backlight module can effectively accommodate and fix the light-guiding plate without the plastic frame of the backlight module of the conventional liquid crystal display, which is beneficial to reduce the overall size of the backlight module, which is conducive to the reduction of the overall thickness of a liquid crystal display using this backlight module and is also conducive to the narrow frame design of the liquid crystal display.

Another objective of the invention is to provide a displaying module that uses a backlight module like the above, which is beneficial to reduce the overall size of the displaying module, which is conducive to the reduction of the overall thickness of a liquid crystal display using this displaying module and is also conducive to the narrow frame design of the liquid crystal display.

A displaying module according to the invention is used in a display and includes a backlight module and a liquid crystal panel. The backlight module includes a back chassis and a light-guiding plate. The back chassis has a bottom plate portion and a side portion bent from the bottom plate portion. The back chassis forms an accommodating space between the bottom plate portion and the side portion. The back chassis has a constraining portion located in the accommodating space. The light-guiding plate is accommodated in the accommodating space. At least a portion of the light-guiding plate is located between the constraining portion and the bottom plate portion. The liquid crystal panel is stacked on the backlight module. Similarly, the backlight module of the displaying module can effectively accommodate and fix the light-guiding plate without the plastic frame of the backlight module of the conventional liquid crystal display, which is beneficial to reduce the overall size of the displaying module, which is conducive to the reduction of the overall thickness of a liquid crystal display using this displaying module and is also conducive to the narrow frame design of the liquid crystal display.

Another objective of the invention is to provide a liquid crystal display that uses a displaying module like the above, which is beneficial to reduce the overall size of the liquid crystal display, which is conducive to the reduction of the overall thickness of the liquid crystal display and is also conducive to the narrow frame design of the liquid crystal display.

A liquid crystal display according to the invention includes a casing, a backlight module, and a liquid crystal panel . The backlight module is disposed in the casing. The backlight module includes a back chassis and a light-guiding plate. The back chassis has a bottom plate portion and a side portion bent from the bottom plate portion. The back chassis forms an accommodating space between the bottom plate portion and the side portion. The back chassis has a constraining portion located in the accommodating space. The light-guiding plate is accommodated in the accommodating space. At least a portion of the light-guiding plate is located between the constraining portion and the bottom plate portion. The liquid crystal panel is disposed in the casing and stacked on the backlight module. Similarly, the backlight module of the displaying module of the liquid crystal display can effectively accommodate and fix the light-guiding plate without the plastic frame of the backlight module of the conventional liquid crystal display, which is conducive to the reduction of the overall size of the liquid crystal display and is also conducive to the narrow frame design of the liquid crystal display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal display of an embodiment according to the invention.

FIG. 2 is a functional block diagram of a displaying module in FIG. 1.

FIG. 3 is a partially-exploded view of the liquid crystal display in FIG. 1.

FIG. 4 is an exploded view of a backlight module in FIG. 3.

FIG. 5 is a sectional view of the liquid crystal display in FIG. 1 along the line X-X.

FIG. 6 is an enlarged view of a back chassis at the circle A in FIG. 4.

FIG. 7 is a sectional view of the liquid crystal display in FIG. 1 along the line Y-Y.

FIG. 8 is a schematic diagram illustrating a variation of the disposition of a constraining portion in FIG. 6

FIG. 9 is a schematic diagram illustrating another variation of the disposition of the constraining portion in FIG. 6

FIG. 10 is a schematic diagram illustrating another variation of the disposition of the constraining portion in FIG. 6

### DETAILED DESCRIPTION

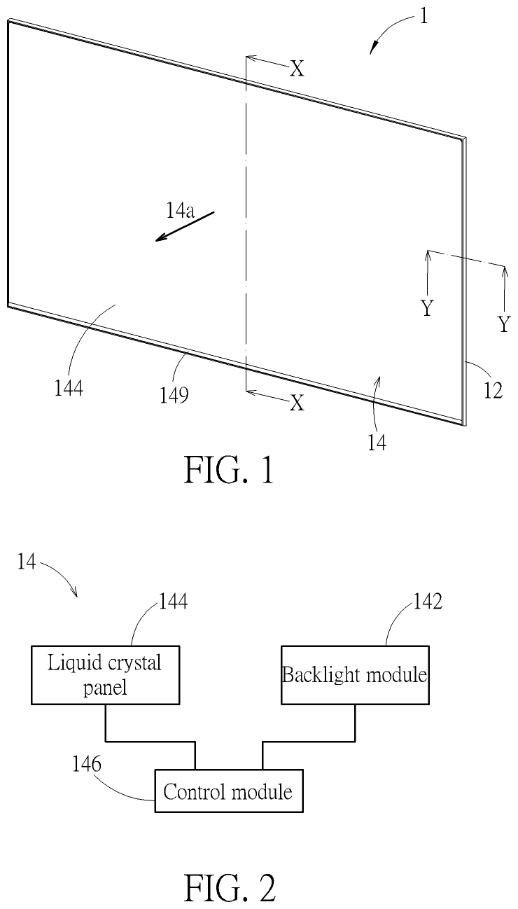

Please refer to FIG. 1 to FIG. 3. A liquid crystal display 1 of an embodiment according to the invention includes a casing 12 and a displaying module 14. The casing 12 has a component receiving space 12a. The displaying module 14 is accommodated in the component receiving space 12a. The displaying module 14 externally displays images in a display direction 14a (indicated by an arrow in FIG. 1). The displaying module 14 includes a backlight module 142, a liquid crystal panel 144, and a control module 146. The control module 146 is electrically connected to the backlight module 142 and the liquid crystal panel 144. The liquid crystal panel 144 is stacked on the backlight module 142 and is exposed from the casing 12. The control module 146 controls the backlight module 142 to provide backlight to the liquid crystal panel 144 and controls the state of each liquid crystal cell of the liquid crystal panel 144 for displaying images.

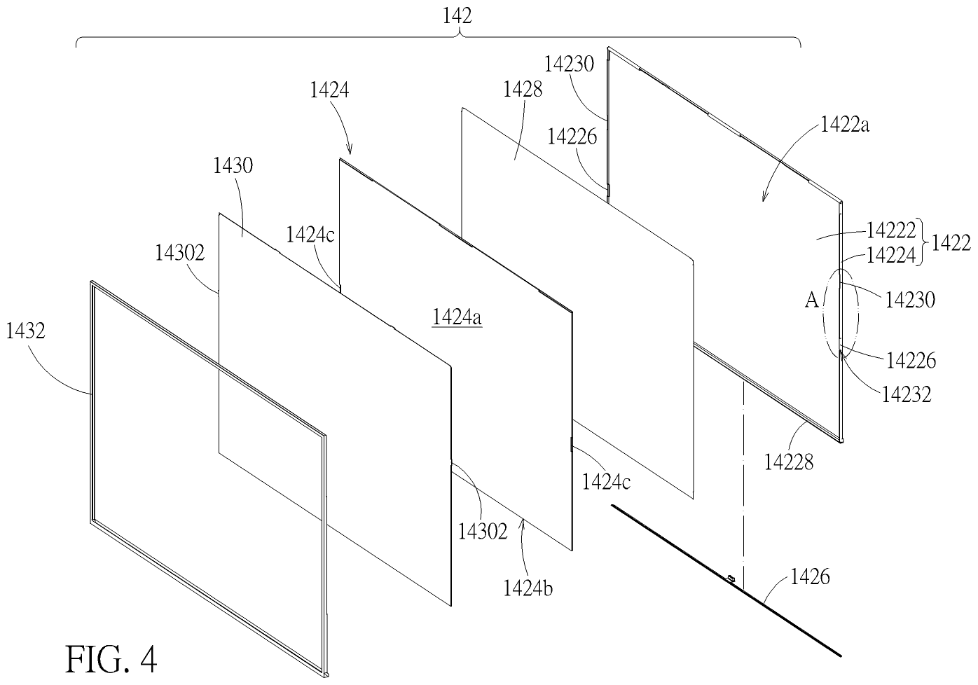

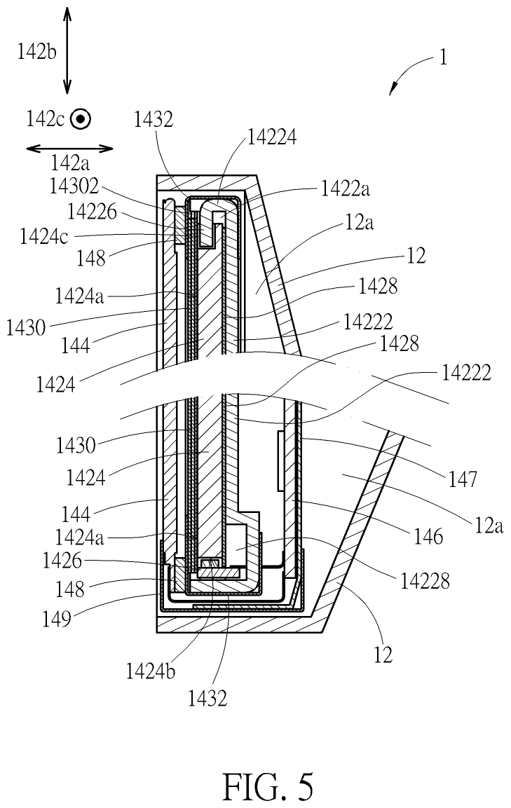

Please also refer to FIG. 4 and FIG. 5. The backlight module 142 includes a back chassis 1422, a light-guiding plate 1424, a light source 1426, a reflection sheet 1428, at least one optical film 1430 (such as but not limited to diffusion sheet, prism sheet, brightness enhancement sheet, etc.), and a side tape 1432. The reflection sheet 1428, the light-guiding plate 1424, and the optical film 1430 are sequentially stacked on the back chassis 1422. The light source 1426 is disposed at a lower side 1424a of the light-guiding plate 1424. The side tape 1432 is located around the backlight module 142 to increase the stability of the overall structure of the backlight module 142. Therein, the back chassis 1422 has a bottom plate portion 14222 and a plurality of side portions 14224 bent and extended from the bottom plate portion 14222. The back chassis 1422 forms an accommodating space 1422a between the bottom plate portion 14222 and the side portions 14224. The back chassis 1422 also has a plurality of constraining portions 14226 located in the accommodating space 1422a and extending toward the inner side of the accommodating space 1422a relative to the side portions 14224 in the accommodating space 1422a. The back chassis 1422 has an accommodating slot 14228 on its lower side.

The light-guiding plate 1424 is accommodated in the accommodating space 1422a. At least a portion of the light-guiding plate 1424 is located between the constraining portions 14226 and the bottom plate portion 14222; in other words, the at least a portion of the light-guiding plate 1424 is located between the constraining portions 14226 and the bottom plate portion 14222 in a first direction 142a (indicated by a double-headed arrow in FIG. 5, which is parallel to the displaying direction 14a) perpendicular to the bottom plate portion 14222, so that the light-guiding plate 1424 can be effectively constrained on the back chassis 1422 at least in the first direction 142a. The light-guiding plate 1424 and the bottom plate portion 14222 extend in parallel. The light-emitting surface 1424a of the light-guiding plate 1424 is perpendicular to the first direction 142a. The reflection sheet 1428 is disposed on another surface of the light-guiding plate 1424 opposite to the light-emitting surface 1424a. The light-guiding plate 1424 has alight incident side surface 1424b close to the accommodating slot 14228.

The light source 1426 can be achieved by a light bar formed by a plurality of light emitting elements (such as but not limited to LEDs) arranged in a straight line, and is accommodated in the accommodating slot 14228 of the back chassis 1422. The light emitting direction of the light source 1426 is toward the light incident side surface 1424b. Light emitted by the light source 1426 will enter the light-guiding plate 1424 from the light incident side surface 1424b and emit out of the light-guiding plate 1424 from the light-emitting surface 1424a. The reflection sheet 1428 can reflect the light traveling toward the bottom plate portion 14222 in the light-guiding plate 1424, which increases the utilization rate of the light. The optical film 1430 is stacked on the light-emitting surface 1424a of the light-guiding plate 1424 in the first direction 142a. The light emitted from the light-emitting surface 1424a passes through the optical film 1430 to provide backlight to the liquid crystal panel 144 that is stacked on the backlight module 142 in the first direction 142a.

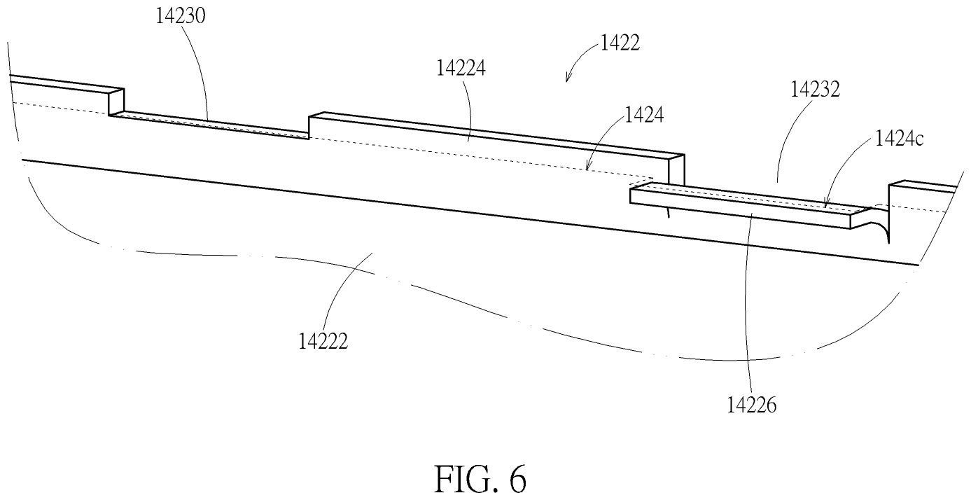

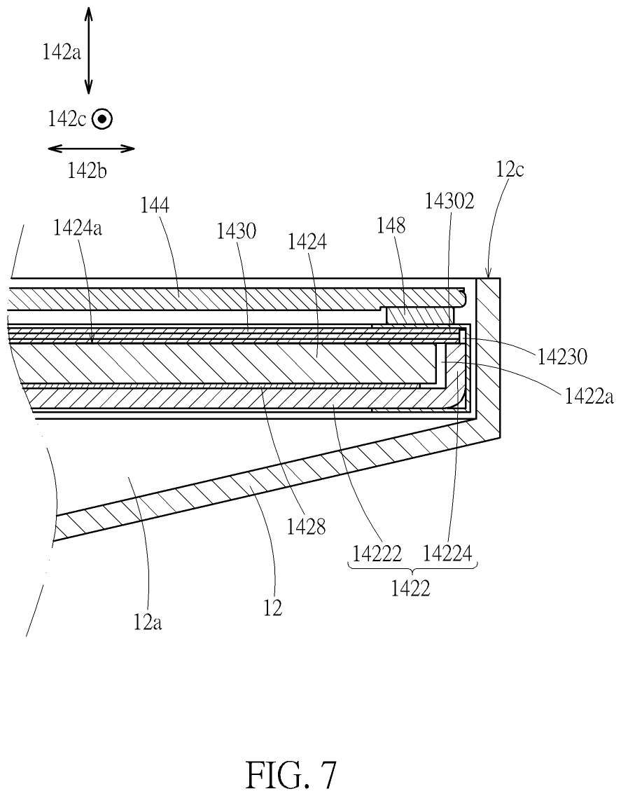

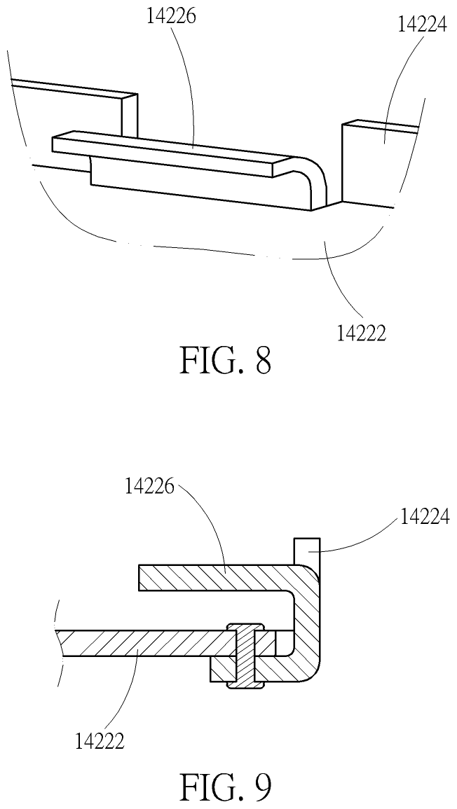

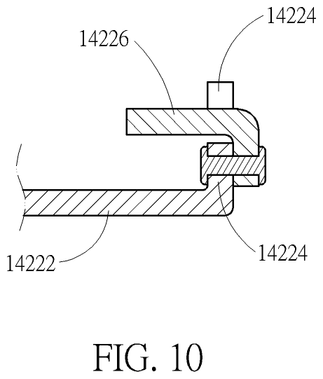

Please refer to FIG. 4, FIG. 6 and FIG. 7. In the embodiment, the constraining portions 14226 bend and extend from the side portion 14224; correspondingly, the light-guiding plate 1424 has a recess 1424c for each constraining portions 14226. The constraining portion 14226 is located in the corresponding recess 1424c, as shown by FIG. 5 and FIG. 6 (in which the profile of the recess 1424c is shown in dashed lines). By the structural interference between the recesses 1424c and the constraining portions 14226, the constraining portions 14226 can prevent the light-guiding plate 1424 from being separated from the back chassis 1422 in the first direction 142a, and can also position the light-guiding plate 1424 in the second directions 142b and 142c (which are indicated by a double-headed arrow in the figures) perpendicular to the first direction 142a. In practice, the constraining portion 14226 may be bent and extended directly from the bottom plate portion 14222 (as shown by FIG. 8). Furthermore, in the embodiment, the whole back chassis 1422 is made of a single metal plate (e.g. by a stamping process); however, it is not limited thereto in practice. For example, the constraining portion 14226 can be fixed (e.g. riveted by an additional part) to the bottom plate portion 14222 (as shown by FIG. 9) or the side portion 14224 (as shown by FIG. 10) ; in practice, the fixing can be achieved by welding (e.g. the riveting shown in FIG. 9 and FIG. 10 can be changed to welding, which will not be described in detail. In addition, as shown by FIG. 6 and FIG. 7, in the embodiment, the constraining portion 14226 is slightly lower than the light-emitting surface 1424a; that is, the constraining portion 14226 is recessed relative to the light-emitting surface 1424a in the first direction 142a, or the light-emitting surface 1424a is protruded relative to the constraining portion 14226 in the first direction 142a. In practice, the constraining portion 14226 may be equal to the light-emitting surface 1424a in the first direction 142a; that is, the constraining portion 14226 is aligned with the light-emitting surface 1424a. This structural configuration is beneficial for the optical film 1430 to be placed flat on the light-emitting surface 1424a.

Furthermore, as shown by FIG. 4, FIG. 6 and FIG. 7, in the embodiment, the optical film 1430 has a plurality of protruding portions 14302 in the second directions 142b and 142c; correspondingly, the side portion 14224 has a plurality of positioning slots 14230. The protruding portions 14302 are located in the positioning slots 14230 correspondingly, which causes the effect of positioning the optical film 1430. In practice, the notch 14232 of the side portion 14224 corresponding to the constraining portion 14226 can also be used as a positioning slot; in this case, the size and position of the protruding portion 14302 of the optical film 1430 are also modified accordingly, which will not be described in addition.

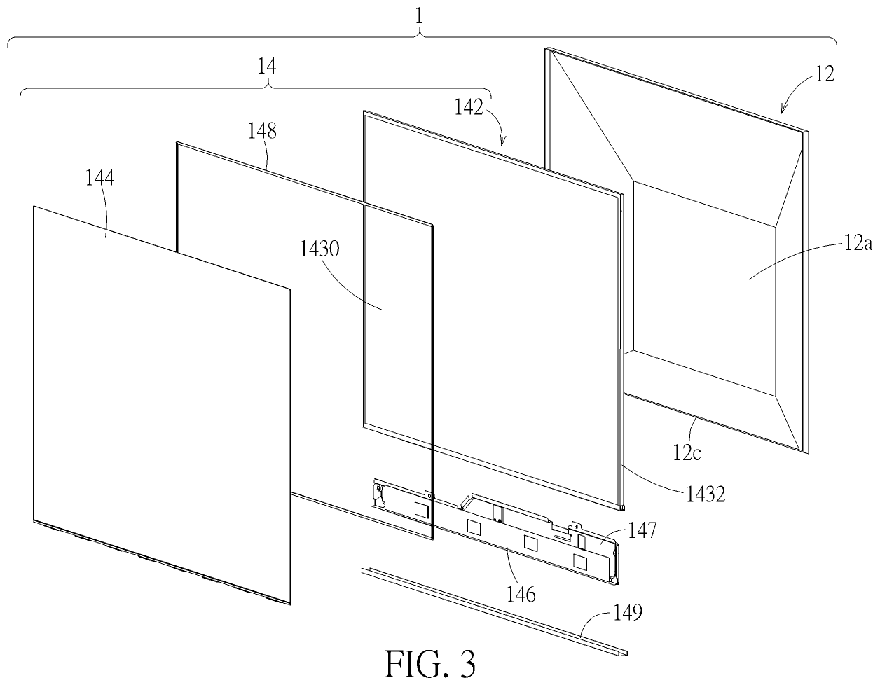

Furthermore, as shown by FIG. 3 to FIG. 5 and FIG. 7, for drawing simplification, the side tape 1432 is shown in a single structural part and roughly completely covers the periphery of the backlight module 142; however, it is not limited thereto in practice. For example, the side tape 1432 is achieved by a plurality of tapes, which cover each side of the backlight module 142 respectively. In the embodiment, the side tape 1432 extends along each side of the backlight module 142 in a C-shaped cross-section, and simultaneously adheres to the back of the bottom plate portion 14222, the side portion 14224, and the optical film 1430, which can fix the optical film 1430 on the light-guiding plate 1424 and also increases the stability of the overall structure of the backlight module 142. Therefore, compared with the backlight module of a conventional liquid crystal display, the backlight module 142 of the embodiment can effectively fix the light-guiding plate 1424 and the optical film 1430 without a plastic frame. Furthermore, in the embodiment, the side tape 1432 can cover the constraining portions 14226, the peripheries of the optical film 1430 and the light-guiding plate 1424, the light source 1426, etc. in the first direction 142a. Besides, the side tape 1432 is opaque, so the light-guiding plate 1424 can cover the light leakage and bright edges that may occur on the light-guiding plate 1424 and affect the uniformity of the backlight.

Furthermore, as shown by FIG. 3, FIG. 5 and FIG. 7, the liquid crystal panel 144 is fixed on the backlight module 142 through a plurality of foam parts 148. The displaying module 14 uses a metal shielding can 147 to cover the control module 146. An underside decorative cover 149 extends along the lower side of the displaying module 14 in a U-shaped cross-section and covers the lower side of the displaying module 14. The underside decorative cover 149 covers the light source 1426 in the first direction 142a. Because the backlight module 142 does not have one like the plastic frame of the backlight module of the conventional liquid crystal display, the thickness of the underside decorative cover 149 will be thinner than that of an underside decorative cover of the conventional liquid crystal display. Similarly, compared with the conventional liquid crystal display, the displaying module 14 (or the backlight module 142 thereof) of the embodiment has a smaller frame structure side wall thickness (equivalent to the sum of the thicknesses of the side portion 14224 of the back chassis 1422 and the side tape 1432). This structural configuration is conducive to the narrow frame and thin design of the liquid crystal display 1.

Those skilled in the art will readily observe that numerous modifications and alterations of the device and method may be made while retaining the teachings of the invention. Accordingly, the above disclosure should be construed as limited only by the metes and bounds of the appended claims.

1. A backlight module comprising:
a back chassis, the back chassis having a bottom plate portion and a side portion bent from the bottom plate portion, the back chassis forming an accommodating space between the bottom plate portion and the side portion, the back chassis having a constraining portion located in the accommodating space;
a light-guiding plate accommodated in the accommodating space, at least a portion of the light-guiding plate being located between the constraining portion and the bottom plate portion;
at least one optical film stacked on the light-guiding plate; and
an opaque tape, the opaque tape adhering to the bottom plate portion, the side portion, and the at least one optical film, the opaque tape covering the constraining portion.

2. The backlight module according to claim 1, wherein the light-guiding plate has a recess, and the constraining portion is located in the recess.

3. The backlight module according to claim 2, wherein the light-guiding plate has a light-emitting surface, and the constraining portion is lower than or equal to the light-emitting surface in a first direction perpendicular to the light-emitting surface.

4. The backlight module according to claim 3, wherein the at least one optical film that is stacked on the light-emitting surface and has a protruding portion in a second direction perpendicular to the first direction, wherein the side portion has a positioning slot, and the protruding portion is located in the positioning slot.

5. (canceled)

6. The backlight module according to claim 1, wherein the constraining portion bends from the side portion or the bottom plate portion.

7. The backlight module according to claim 1, wherein the constraining portion riveted to the side portion or the bottom plate portion.

8. A displaying module comprising:
a backlight module comprising:
a back chassis, the back chassis having a bottom plate portion and a side portion bent from the bottom plate portion, the back chassis forming an accommodating space between the bottom plate portion and the side portion, the back chassis having a constraining portion located in the accommodating space;
a light-guiding plate accommodated in the accommodating space, at least a portion of the light-guiding plate being located between the constraining portion and the bottom plate portion;
at least one optical film stacked on the light-guiding plate; and
an opaque tape, the opaque tape adhering to the bottom plate portion, the side portion, and the at least one optical film, the opaque tape covering the constraining portion; and
a liquid crystal panel stacked on the backlight module.

9. The displaying module according to claim 8, further comprising at least one foam part, wherein the liquid crystal panel is fixed to the backlight module through the at least one foam part.

10. The displaying module according to claim 8, wherein the light-guiding plate has a recess, the constraining portion is located in the recess, the light-guiding plate has a light-emitting surface, and the constraining portion is lower than or equal to the light-emitting surface in a first direction perpendicular to the light-emitting surface.

11. The displaying module according to claim 10, wherein the the at least one optical film that is stacked on the light-emitting surface and has a protruding portion in a second direction perpendicular to the first direction, the side portion has a positioning slot, and the protruding portion is located in the positioning slot.

12. (canceled)

13. The displaying module according to claim 8, wherein the constraining portion bends and extends from the side portion or the bottom plate portion.

14. The displaying module according to claim 8, wherein the constraining portion riveted to the side portion or the bottom plate portion.

15. A liquid crystal display comprising:
a casing;
a backlight module disposed in the casing, the backlight module comprising:
a back chassis, the back chassis having a bottom plate portion and a side portion bent from the bottom plate portion, the back chassis forming an accommodating space between the bottom plate portion and the side portion, the back chassis having a constraining portion located in the accommodating space;
a light-guiding plate accommodated in the accommodating space, at least a portion of the light-guiding plate being located between the constraining portion and the bottom plate portion;
at least one optical film stacked on the light-guiding plate; and
an opaque tape, the opaque tape adhering to the bottom plate portion, the side portion, and the at least one optical film, the opaque tape covering the constraining portion; and
a liquid crystal panel disposed in the casing and stacked on the backlight module.

16. The liquid crystal display according to claim 15, wherein the light-guiding plate has a recess, the constraining portion is located in the recess, the light-guiding plate has a light-emitting surface, and the constraining portion is lower than or equal to the light-emitting surface in a first direction perpendicular to the light-emitting surface.

17. The liquid crystal display according to claim 16, wherein the at least one optical film that is stacked on the light-emitting surface and has a protruding portion in a second direction perpendicular to the first direction, the side portion has a positioning slot, and the protruding portion is located in the positioning slot.

18. (canceled)

19. The liquid crystal display according to claim 15, wherein the constraining portion bends and extends from the side portion or the bottom plate portion.

20. The liquid crystal display according to claim 15, wherein the constraining portion riveted to the side portion or the bottom plate portion.
